(19) United States
(12) Patent Application Publication
(10) Pub. No.: US 2020/0371255 A1
(43) Pub. Date: Nov. 26, 2020

(54) ELECTRONIC DEVICE, METHOD AND COMPUTER PROGRAM FOR DETERMINING AND USING A DISTANCE IN DEPENDENCE ON MATCHING CONSTELLATION INFORMATION

(71) Applicant: SIGNIFY HOLDING B.V., EINDHOVEN (NL)

(72) Inventors: HARRY BROERS, 'S-HERTOGENBOSCH (NL); MAURICE HERMAN JOHAN DRAAIJER, ITTERVOORT (NL); JAN EKKEL, OSS (NL); RUBEN RAJAGOPALAN, NEUSS (DE); WEI PIEN LEE, EINDHOVEN (NL)

(21) Appl. No.: 16/635,340

(22) PCT Filed: Jul. 30, 2018
(86) PCT No.: PCT/EP2018/070628

§ 371 Date: Jan. 30, 2020

(30) Foreign Application Priority Data
Aug. 1, 2017 (EP) 17184147.1

(51) Int. Cl. G01S 19/51; G01S 19/39; G01S 19/37

(52) U.S. Cl. CPC G01S 19/51; G01S 19/37; G01S 19/396

(57) ABSTRACT

An electronic device is configured to determine a first location of a first device (12) and a second location of a second device (14). The first location and the second location are obtained using a beacon, e.g. satellite, navigation system. The electronic device is further configured to determine first constellation information representing a beacon, e.g. satellite, constellation used for obtaining the first location and second constellation information representing a beacon, e.g. satellite, constellation used for obtaining the second location, determine whether the first constellation information and the second constellation information match, and determine and use a distance between the first location and the second location if the first constellation information and the second constellation information are determined to match. This distance can be used to determine pole tilt, for example.

### FIELD OF THE INVENTION

The invention relates to an electronic device for determining a distance between devices.

The invention further relates to a method of determining a distance between devices.

The invention also relates to a computer program product enabling a computer system to perform such a method.

### BACKGROUND OF THE INVENTION

The cost of manually inspecting outdoor luminaires contributes significantly to the overall costs (including purchase and maintenance costs) of the outdoor luminaires. Remote diagnostics via sensing solutions and data analytics lowers maintenance costs by sending inspection and repair crews only when and where needed, improving operational efficiency. Orientation changes of a luminaire can reduce the light quality and therefore need to be corrected. The distance between neighboring outdoor luminaires can be used to determine whether such an orientation change, e.g. due to pole tilt or pole swing, has occurred.

US 2015/0276399A1 discloses determining the position of a receiver relative to a specific luminaire within the field of view (FOV) of a camera of the receiver. The relative position may be calculated by determining the distance and the orientation of the receiver relative to the luminaire. The distance relative to the luminaire may be calculated using the observed size of the luminaire in an image generated by the receiver camera, the image zoom factor, and actual geometry of the luminaire. The orientation relative to the luminaire may be determined using a fiducial associated with the luminaire that can be used as an orientation cue.

A drawback of using the method of US 2015/0276399A1 to measure the distance between two outdoor luminaires is that a relatively expensive camera needs to be incorporated into each outdoor luminaire and either an image processor needs to be incorporated into each outdoor luminaire or a relatively large amount of (image) data needs to be transmitted by each outdoor luminaire.

GB 2 312 112 A discloses a Global Positioning System (GPS) avalanche transceiver for skiers that could dramatically improve the chances for skiers of being rescued in the event of being buried by an avalanche. Conventional transceivers rely on relative signal strength to locate victims and are difficult to use effectively. A GPS avalanche transceiver transmits information about a skiers position derived from the US Air Force Naystar satellite system. A rescuer similarly equipped can use the GPS information transmitted by the buried skier and locally derived GPS information to get an accurate indication of the distance and direction to the buried skier. To ensure that the transmitting and the receiving GPS avalanche transceivers base their measurements on the same set of satellites and make their measurements at approximately the same time, information about which GPS satellites that are being used by the transmitting avalanche transceiver is also sent to the receiving transceiver.

US 2009/140916 A1 relates to a calculation apparatus for calculation of relative inter-vehicle position, a transmission apparatus for transmitting information to the calculation apparatus, and a program for use in the calculation apparatus and the transmission apparatus. An on-board communication equipment on each of two vehicles receives a radio wave from two or more GPS satellites, and determines a carrier wave phase of the received radio wave. Then, the on-board communication equipment on one vehicle receives, from the other vehicle, information on the carrier wave phase observed in the other vehicle. Further, the on-board communication equipment calculates a relative position of the own vehicle relative to the other vehicle by a Carrier-Phase DGPS positioning based on a difference between two carrier wave phases (e.g., single difference, double difference or the like), that is, one from the own vehicle and one from the other vehicle, both having the same observation time, from among the available carrier wave phases.

### SUMMARY OF THE INVENTION

It is a first object of the invention to provide an electronic device, which is able to measure a distance between two devices in an accurate, but cost-effective manner.

It is a second object of the invention to provide a method, which is able to measure a distance between two devices in an accurate, but cost-effective manner.

In a first aspect of the invention, the electronic device comprises at least one processor configured to determine a first location of a first device and a second location of a second device, said first location and said second location being obtained using a beacon navigation system, determine first constellation information representing a beacon constellation used for obtaining said first location and second constellation information representing a beacon constellation used for obtaining said second location, determine whether said first constellation information and said second constellation information match, and determine and use a distance between said first location and said second location if said first constellation information and said second constellation information are determined to match. Said beacon navigation system may be the Global Positioning System (GPS).

The inventors have recognized that it is more cost-effective to embed beacon sensors in devices such as outdoor luminaires and use a beacon navigation system to determine their locations than to determine their locations in a different manner, but that frequently, these determined locations are not accurate enough. The inventors have recognized that atmospheric disturbances affect the absolute localization accuracy of close-by GPS receivers in the same way and that a distance between two locations can be determined with sufficient accuracy, with an accuracy up to a centimeter, if the beacon constellations used for obtaining the two locations match, e.g. are the same or substantially the same. The distance may be determined only if there is a match or may always be determined, but not used if there is no match. The use of the distance may comprise the displaying of the distance and/or a warning based on the distance and/or may comprise configuring one of the devices based on the distance, for example.

It is especially cost-effective to embed beacon sensors in devices such as outdoor luminaires, because the beacon sensors can be used for other purposes as well. For example, the absolute location of the device may be used for location-awareness, which simplifies the installation, commissioning and maintenance of the device. Furthermore, the clock of the beacon sensor (e.g. a GPS clock) may be used to switch on and off the device at certain times instead of a photocell measuring the ambient light level. Using beacon sensors does not only lead to lower operation cost. Deployment of new installations is typically much faster. Moreover, the errors made by manual commissioning are often ruled out almost completely. These errors due to manual, human, intervention is a cause of many hidden costs, not only during installation, but also much later.

The beacons may be satellites and the beacon constellation may be a satellite constellation, but other localization systems in which only a subset of beacons is used for determining the location, i.e. where a certain beacon constellation is used for determining the location, may also be used. The invention may be applied to any localization method which uses beacons and suffers from atmospheric disturbance and in which atmospheric disturbance varies as a function of time. For example, if many audio beacons would be installed (instead of RF satellite beacons) with different ultrasonic frequencies and a few of them would be selected to determine the device's position (using an ultrasonic sensitive microphone), the invention may also be beneficial.

The beacon sensors may be used in other devices than luminaires, e.g. in a grid of surveillance cameras or in another sensor grid. For example, the observation area of a surveillance camera may shift due to a displacement/rotation of the camera and this may result in a specific region of interest in the captured image not observing a desired object or location (e.g. entrance). Determined distances between cameras may be used to detect such an occurrence.

Said at least one processor may be configured to use said distance between said first location and said second location by configuring at least one of said first device and said second device based on said distance. The determined distance is accurate enough to distinguish between two very nearby devices, e.g. two luminaires mounted on the same light pole, and therefore enables fully automatic commissioning/configuration of the devices.

Said at least one processor may be configured to use said distance between said first location and said second location by comparing said distance with an expected distance and providing a warning if a difference between said distance and said expected distance exceeds a predetermined threshold. This makes it possible to send inspection and repair crews only when and where needed and thereby lowers maintenance costs. The distance can be used to determine pole tilt or rotation around the vertical axis of a light pole, for example.

Said expected distance may be a distance between a previously determined first location of said first device and a previously determined second location of said second device, said previously determined first location and said previously determined second location being obtained using said beacon navigation system. By automatically determining the expected distance when the devices are in the desired locations instead of requiring the expected distance to be manually entered, inaccuracies resulting from the manual entering are avoided.

Said at least one processor may be configured to determine a dilution of precision value in relation to at least one of said first constellation information and said second constellation information, compare said dilution of precision value with a predetermined value, and determine and use said distance between said first location and said second location if said first constellation information and said second constellation information are determined to match and said determined dilution of precision value is lower than said predetermined value. If the determined dilution of precision is lower than the predetermined value, the distance is considered sufficiently accurate for the intended use. The predetermined value may depend on how the distance is intended to be used.

Said at least one processor may be configured to determine a new first location of said first device and a new second location of said second device if said first constellation information and said second constellation information are determined not to match, said new first location and said new second location being obtained using said beacon navigation system, determine new first constellation information representing a beacon constellation used for obtaining said new first location and new second constellation information representing a beacon constellation used for obtaining said new second location, determine whether said new first constellation information and said new second constellation information match, and determine and use a distance between said new first location and said new second location if said new first constellation information and said new second constellation information are determined to match. It is often not possible to instruct a beacon sensor to use a certain beacon constellation and a beacon sensor typically changes to a different beacon constellation regularly. Therefore, it is advantageous to repeat sensor measurements until the sensors use the same beacon constellation.

Said at least one processor may be configured to determine said distance between said first location and said second location and use said distance if said distance is lower than a predetermined maximum distance and said first constellation information and said second constellation information are determined to match. The first and second constellation information will normally only match if the first and second device are located close enough to each other. If no list/database of neighboring devices is available, two devices for which to determine the distance can automatically be determined using a maximum distance parameter. Thus, the distance is only determined and used if the distance is lower than the predetermined distance.

Said first device and said second device may be outdoor luminaires on different light poles, wherein a distance between said different light poles is 30 kilometers or less. If the distance is larger than 30 kilometers, the atmospheric disturbance increases significantly resulting in an increasing and unpredictable offset of the determined location compared to the actual location, especially in GPS receivers. Said first device and said second device may be outdoor luminaires on neighboring light poles, for example.

The first location and the second location may be determined using another beacon navigation system than GPS. In this case, differences in constellation information may cause an increasing and unpredictable offset at smaller distances than 30 kilometers, especially when indoor beaconing techniques like Ultra Wideband (UWB) beaconing are used. When indoor beaconing techniques are used, other factors than atmospheric disturbances may be result in an increasing and unpredictable offset of the determined location compared to the actual location. It could be that an object is disturbing/blocking the signal from one or more beacons to the receiver. This will result in different absolute positioning accuracies for different receivers and thus influence the distance determination. By determining the distance only if the locations of both devices are determined using the same beacon(s), the distance becomes more accurate. It may be possible to specify which beacons need to be used to determine the first location and the second location. In the most extreme situation, only one beacon to which both the first device and the second device have direct line-of-sight is used to determine the distance between the first location and the second location.

Said at least one processor may be configured to determine a third location of a third device, said third device being an outdoor luminaire on the same light pole as said second device and said third location being obtained using said beacon navigation system, determine third constellation information representing a beacon constellation used for obtaining said third location, determine whether said first constellation information, said second constellation information and said third constellation information match, determine a distance between said first location and said second location and a further distance between said first location and said third location if said first constellation information, said second constellation information and said third constellation information are determined to match, compare said distance with said further distance, and use a result of said comparison. In case a light pole has two or more luminaires, measurement of the distances between each of at least two of these luminaires and a luminaire on a different light pole makes it easier to distinguish between pole tilt and rotation around the vertical axis. Since the relative positions of the luminaires on the same pole are normally rigid, a pole tilt will result in very similar lateral displacements, while an axial pole rotation will not.

In a second aspect of the invention, the method comprises determining a first location of a first device and a second location of a second device, said first location and said second location being obtained using a beacon navigation system, determining first constellation information representing a beacon constellation used for obtaining said first location and second constellation information representing a beacon constellation used for obtaining said second location, determining whether said first constellation information and said second constellation information match, and determining and using a distance between said first location and said second location if said first constellation information and said second constellation information are determined to match. The method may be implemented in hardware and/or software.

Moreover, a computer program for carrying out the methods described herein, as well as a non-transitory computer readable storage-medium storing the computer program are provided. A computer program may, for example, be downloaded by or uploaded to an existing device or be stored upon manufacturing of these systems.

A non-transitory computer-readable storage medium stores at least one software code portion, the software code portion, when executed or processed by a computer, being configured to perform executable operations comprising: determining a first location of a first device and a second location of a second device, said first location and said second location being obtained using a beacon navigation system, determining first constellation information representing a beacon constellation used for obtaining said first location and second constellation information representing a beacon constellation used for obtaining said second location, determining whether said first constellation information and said second constellation information match, and determining and using a distance between said first location and said second location if said first constellation information and said second constellation information are determined to match.

As will be appreciated by one skilled in the art, aspects of the present invention may be embodied as a device, a method or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of devices, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

### BRIEF DESCRIPTION OF THE DRAWINGS

These and other aspects of the invention are apparent from and will be further elucidated, by way of example, with reference to the drawings, in which:

FIG. 1 depicts an example of two outdoor luminaires on the same light pole;

FIG. 2 depicts a top view of the outdoor luminaires of FIG. 1;

FIG. 3 depicts an example of an outdoor luminaire on a tilted pole;

FIG. 4 depicts an example (top view) of an outdoor luminaire on a light pole that has rotated arounds its vertical axis;

FIG. 5 is a block diagram of an embodiment of the electronic device of the invention;

FIG. 6 depicts an example of a satellite constellation with a poor dilution of precision;

FIG. 7 depicts an example of a satellite constellation with a good dilution of precision;

FIG. 8 is a flow diagram of an embodiment of the method of the invention; and

FIG. 9 is a block diagram of an exemplary data processing system for performing the method of the invention.

Corresponding elements in the drawings are denoted by the same reference numeral.

### DETAILED DESCRIPTION OF THE EMBODIMENTS

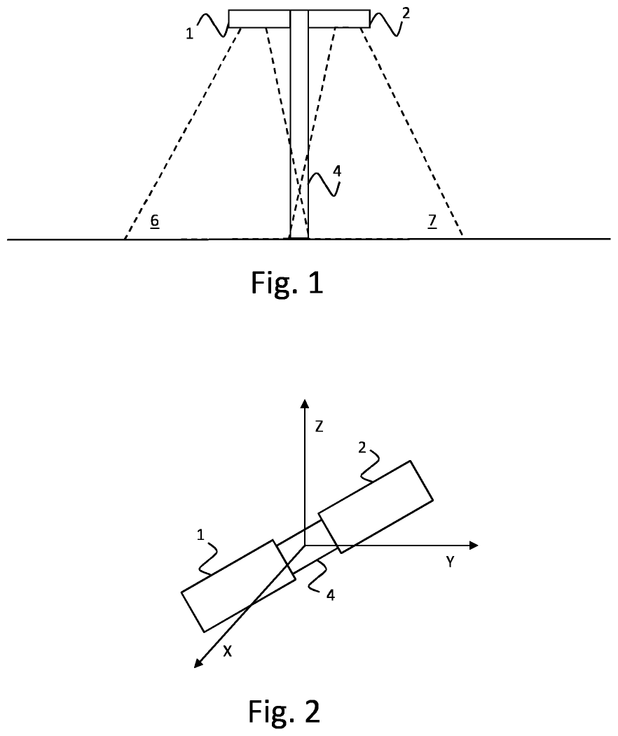

FIG. 1 depicts a light pole 4 and two luminaires mounted on the light pole 4: luminaire 1 and luminaire 2. Luminaire 1 emits light 6 and luminaire 2 emits light 7. By embedding beacon (e.g. GPS) sensors in luminaires 1 and 2 and applying the invention, fully automatic commissioning and/or diagnostics can be enabled. The beacon, e.g. satellite, sensors typically determine a longitude, latitude and altitude. This longitude, latitude and altitude may be converted to X, Y and Z coordinates and the distance may be determined from these X, Y and Z coordinates, for example. FIG. 2 depicts a top view of the luminaires of FIG. 1 along with the X, Y and Z axis.

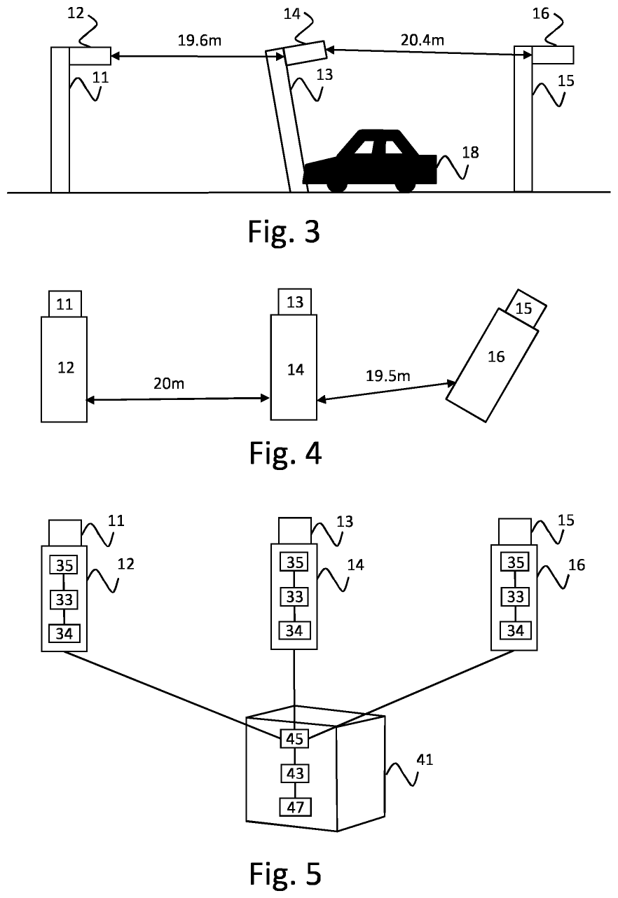

The relevant distance between luminaires may be used to determine whether something has happened to a light pole on which a luminaire is mounted and possibly what has happened to this light pole. A first example of what can happen to a light pole is pole tilt. This is illustrated with the help of FIG. 3. Luminaires 12, 14 and 16 are mounted on light poles 11, 13 and 15 respectively. Light pole 13 has tilted, because a car 18 has collided with it. The distance measured between luminaires 12 and 14 is 19.6 meters and the distance measured between luminaires 14 and 16 is 20.4 meters. Since the expected distance between luminaires 12 and 14 and between luminaries 14 and 16 is 20 meters, it can be concluded that something has happened to light pole 13. If only the distance between luminaires 12 and 14 is measured, it would be possible to conclude from the measured 19.6 meters that something has happened to either light pole 11 or light pole 13. A second example of what can happen to a light pole is rotation around the vertical axis of the light pole. This is illustrated with the help of FIG. 4. Light pole 16 has rotated arounds its vertical axis 30 degrees. The distance measured between luminaires 12 and 14 is 20 meters and the distance measured between luminaires 14 and 16 is 19.5 meters. Since the expected distance between luminaires 12 and 14 and between luminaries 14 and 16 is 20 meters, it can be concluded that something has happened to light pole 16. If something would have happened to light pole 14, the distance measured between luminaires 12 and 14 would not be 20 meters.

In the examples of FIGS. 3 and 4, it is not known what has caused the displacement of the luminaire. The displacement of the luminaire could be due to the pole tilt as illustrated in FIG. 3, axial rotation of the pole as illustrated in FIG. 4, or a combination of both. Pole tilt normally results in a height difference of the luminaires, but this height difference is relatively small compared the lateral displacement. The height difference for a certain lateral displacement is strongly related to the total height of the pole.

In order to determine the distance sufficiently accurate and in a cost-effective manner, the electronic device and method of the invention can be used. FIG. 5 shows a first embodiment of an electronic device of the invention, a computer 41. The computer 41 is used as a light management system. The computer 41 comprises a processor 43, a transceiver 45 and storage means 47. The processor 43 is configured to determine a first location of a first device, e.g. luminaire 12, and a second location of a second device, e.g. luminaire 14. The first location and the second location are obtained using a satellite navigation system, e.g. GPS. The processor 43 is further configured to determine first constellation information representing a satellite constellation used for obtaining the first location and second constellation information representing a satellite constellation used for obtaining the second location. The processor 43 is further configured to determine whether the first constellation information and the second constellation information match. The processor 43 is further configured to determine and use a distance between the first location and the second location if the first constellation information and the second constellation information are determined to match.

For maximum accuracy, the two locations must be determined using the exact same beacon, e.g. satellite, constellation. The atmospheric disturbance seen from every satellite is different, therefore the distance between two locations should only be determined if the same satellites are used in both GPS sensors. In almost all GPS sensors, except exotic real differential GPS sensors, the satellites used for obtaining the location cannot be selected. The constellation information is therefore transmitted to the computer 41 to make sure that only data is compared that is based on the same satellites in that specific second.

In the embodiment of FIG. 5, each of the luminaires 12, 14 and 16 comprises a processor 33, a GPS sensor 34 and a transceiver 35. The processor 33 repeatedly receives from the GPS sensor 34 the location of the luminaire, the constellation information used for obtaining this location and the time at which the location was obtained and uses the transceiver 35 to transmit this information to the computer 41, e.g. using GPRS, UMTS, LTE or 5G. The computer 41 uses the transceiver 45 to send an acknowledgement of receipt to the luminaires 12, 14 and 16. In an alternative embodiment, the transceiver 45 is replaced with a receiver and the computer 41 does not send an acknowledgement of receipt to the luminaires 12, 14 and 16.

In the embodiment of FIG. 5, the processor 43 is configured to determine a new first location of the first device, i.e. the luminaire 12, and a new second location of the second device, i.e. the luminaire 14, if the first constellation information and the second constellation information are determined not to match. The new first location and the new second location are obtained using the satellite navigation system by the luminaires 12 and 14 and transmitted to the computer 41. The processor 43 is further configured to determine new first constellation information representing a satellite constellation used for obtaining the new first location and new second constellation information representing a satellite constellation used for obtaining the new second location. The new first constellation information and the new second constellation information are transmitted by the luminaires 12 and 14 to the computer 41 along with the afore-mentioned locations. The processor 43 is further configured to determine whether the new first constellation information and the new second constellation information match and determine and use a distance between the new first location and the new second location if the new first constellation information and the new second constellation information are determined to match.

The location of the luminaire, the constellation information used for obtaining this location and the time at which the location was obtained is thus repeatedly transmitted by the luminaires and repeatedly received by the computer 41, which only compares data that is based on the same satellites in that specific second or only uses a distance based on such data. This might take a while because all GPS sensors decides individually and, in a practical situation, GPS sensors typically have a different view of the sky with trees and buildings in their surroundings. However, at a certain moment in time, there is a very high probability there is a match in terms of satellites used.

In the embodiment of the computer 41 shown in FIG. 5, the computer 41 comprises one processor 43. In an alternative embodiment, the computer 41 comprises multiple processors. The processor 43 of the computer 41 may be a general-purpose processor, e.g. from Intel or AMD, or an application-specific processor. The processor 43 of the computer 41 may run a Windows or Unix-based operating system for example. In the embodiment shown in FIG. 5, a receiver and a transmitter have been combined into a transceiver 45. In an alternative embodiment, one or more separate receiver components and zero or more separate transmitter components are used. In an alternative embodiment, multiple transceivers are used instead of a single transceiver. The transceiver 45 may use one or more wireless communication technologies to transmit and receive data, e.g. GPRS, UMTS, LTE and/or 5G. The processor 43 may use the transceiver 45 to remotely commission/configure one or more of the luminaires 12, 14 and 16, e.g. based on the determined distance.

In the embodiment shown in FIG. 5, the computer 41 further comprises storage means 47. The storage means may be used to store previously determined locations and corresponding constellation information, previously determined distances, manually entered expected distances and/or warnings, for example. The storage means 47 may comprise one or more memory units. The storage means 47 may comprise solid state memory, for example. In the embodiment of FIG. 5, the electronic device of the invention is embodied by a computer. In an alternative embodiment, the electronic device of the invention is embodied by a luminaire or by a different type of electronic device. The computer 41 may comprise other components typical for a computer, e.g. a power supply, a keyboard, a display and/or a touchscreen.

In the embodiment shown in FIG. 5, the storage means 47 comprises a database of luminaires which indicates which luminaires are located on neighboring light poles and the processor 43 is configured to determine distances for all pairs of luminaires on neighboring light poles. In an alternative embodiment, the processor 43 is configured to determine the distance between the first location and the second location and use the distance if the distance is lower than a predetermined maximum distance and the first constellation information and the second constellation information are determined to match. This allows the processor 43 to link luminaires in a database based on the locations received from the luminaires and determine distances for all pairs of linked luminaires.

The determined distance may be used for commissioning and the invention is in this case especially beneficial when multiple luminaires are mounted on a light pole. In addition or instead of using the determined distance for commissioning, the determined distance may be used for diagnostics. This is the case in the embodiment shown in FIG. 5, wherein the processor 43 is configured to use the determined distance between the first location and the second location by comparing the distance with an expected distance and providing a warning if a difference between the distance and the expected distance exceeds a predetermined threshold.

As a first example, a warning may be provided in relation to luminaires 12 and 14 of FIG. 3, because the difference between the determined distance, 19.6 meters, and the expected distance, 20 meters, exceeds 10 centimeters, and a warning may be provided in relation to luminaires 14 and 16 of FIG. 3, because the difference between the determined distance, 20.4 meters, and the expected distance, 20 meters, exceeds 10 centimeters. As a second example, a warning may be provided in relation to luminaires 14 and 16 of FIG. 4, because the difference between the determined distance, 19.5 meters, and the expected distance, 20 meters, exceeds 10 centimeters.

In these examples, the poles are assumed to be mounted with an interspacing of 20 meters. When the difference between the measured distance and the expected distance exceeds a certain threshold, a warning may be provided. The expected distance may be pre-programmed by the manufacturer or installer based on the luminaire spacing of the light design, for example. A threshold of 10 centimeters may be used, for example, when the GPS module is located 40 cm from the light pole. A rotation of 10 degrees would result in a translation of lcm and 7 cm in respectively the x and y-axis. Pole tilt of a luminaire at 6 m with 2 degrees would result in a translation of around 20 cm in the horizontal plane.

As a third example, a warning may be provided in relation to luminaire 14 of FIG. 3, because the difference between the determined distance between luminaires 12 and 14, 19.6 meters, and the expected distance, 20 meters, exceeds 10 centimeters, and the difference between the determined distance between luminaires 14 and 16, 20.4 meters, and the expected distance, 20 meters, exceeds 10 centimeters. As a fourth example, a warning may be provided in relation to luminaire 16 of FIG. 4, because the difference between the determined distance between luminaires 14 and 16, 19.5 meters, and the expected distance, 20 meters, exceeds 10 centimeters, and the difference between the determined distance between luminaires 12 and 14, 20 meters, and the expected distance, 20 meters, does not exceed 10 centimeters. Thus, to determine which pole is tilted the distance between three sensors/luminaires is needed. A majority vote may be used to identify the tilted pole, for example.

In an alternative embodiment, the distances between more than three luminaires are considered. For example, if the soil is instable, all luminaires might move move/tilt the same amount, resulting in no distance change between two luminaires. Using distances between more luminaires may improve the situation and may solve the issue of soil motion. In this alternative embodiment, the average of distances between many pairs of luminaires may be determined and this average may be used as a reference to compare each determined distance with. The more locations are determined with the same beacon, e.g. satellite, constellation the more precise this reference (relative) distance is.

The expected distance referred to above is a manually entered distance in the embodiment shown in FIG. 5. In an alternative embodiment, the expected distance between luminaires 12 and 14 is a distance between previously determined locations of luminaires 12 and 14 and the expected distance between luminaires 14 and 16 is a distance between previously determined locations of luminaires 14 and 16. For example, instead of assuming that poles are typically mounted with an interspacing of 20 meters, a change in distances could be used.

When a determined distance deviates from a previously determined distance, a warning may be provided. The determined distance may be compared with a single previously determined distance or with a more reliable and accurate average of previously determined distances within a time frame. The latter can be used to determine pole swing for which the distance between two locations needs to be obtained at least twice at different times. If the pole sway characteristics (e.g. average orientation, frequency and amplitude) are needed, time series analysis of the previously determined distances is required. Based on the average orientation and sway amplitude between two devices, a warning may be provided in case of excessive sway and/or deviation from the average orientation. Frequency analysis can be used to characterize the swinging behavior of both devices (unless their swinging behavior is identical so that they seem to be static, but the probability of this is very low). Normally, a GPS reading is performed every second. If a pole swing is unclear, GPS receiver readings can be intensified to more than one per second. This is normally not done, but may allow a pole swing to be determined more accurately.

In the embodiment shown in FIG. 5, only one luminaire is mounted on each light pole. In an alternative embodiment, multiple luminaires are mounted on a light pole, as shown in FIG. 1. In this alternative embodiment, the processor 43 may be configured to determine a third location of a third device, the third device being an outdoor luminaire on the same light pole as the second device. The third location is obtained using the satellite navigation system. The processor 43 may then be further configured to determine third constellation information representing a satellite constellation used for obtaining the third location and determine whether the first constellation information, the second constellation information and the third constellation information match.

The processor 43 may then be further configured to determine a distance between the first location and the second location and a further distance between the first location and the third location if the first constellation information, the second constellation information and the third constellation information are determined to match, e.g. are the same or substantially the same. The processor 43 may then be further configured to compare the distance with the further distance and use a result of the comparison, e.g. to distinguish between pole tilt and axial pole rotation. Since the relative positions of the luminaires on the same pole are normally rigid, a pole tilt will result in very similar lateral displacements, while an axial pole rotation will not.

In the embodiment shown in FIG. 5, the processor 43 is configured to determine a dilution of precision (DOP, also referred to as geometric dilution of precision) value in relation to at least one of the first constellation information and the second constellation information, compare the dilution of precision value (which is ideal when lower than 1 and poor when higher than 20) with a predetermined value, e.g. 2, and determine and use the distance between the first location and the second location if the first constellation information and the second constellation information are determined to match and the determined dilution of precision value is lower than the predetermined value. If the first constellation and the second constellation are identical, then it is not necessary to determine both DOP values. If the first constellation and the second constellation are not identical, then it may be beneficial to obtain both DOP values and make sure that both DOP values are lower than the predetermined value. The processor 33 of the luminaires uses the transceiver 35 to transmit the DOP value along with the location to the computer 41. The processor 43 of the computer 41 uses the transceiver 45 to receive the DOP values from the luminaires.

The Dilution of Precision can be expressed as a number of separate measurements: HDOP—horizontal dilution of precision, VDOP—vertical dilution of precision, PDOP—position (3D) dilution of precision and TDOP—time dilution of precision. These measurements depend on the beacon constellation. In case of satellite reception, these measurements are affected by objects obstructing the satellite sensor's view of the satellites. The DOP value plays a less important role in determining the distance between two devices whose locations are obtained using the same beacon constellation, which results in two measurements with the same DOP value, than it would in determining an absolute position of a single device.

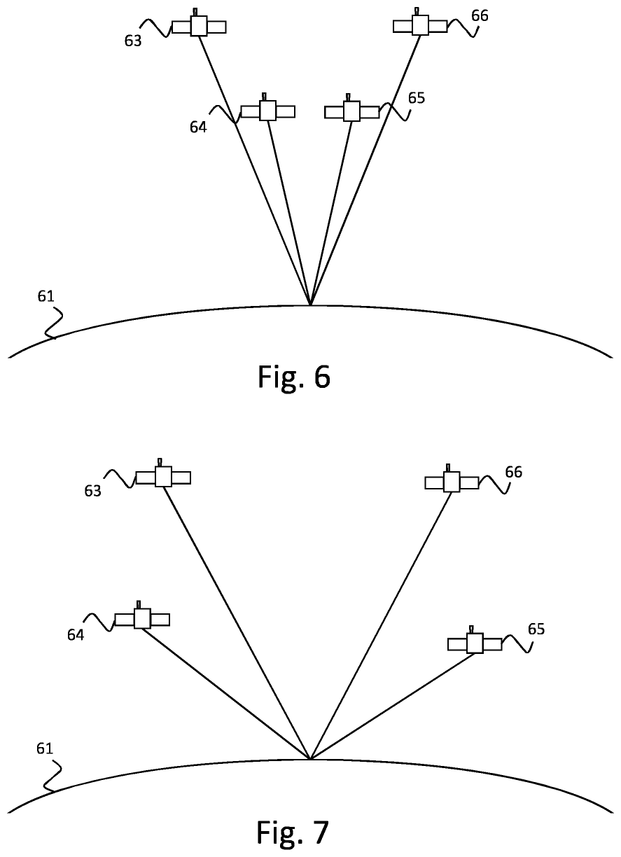

Neglecting tropospheric and ionospheric effects, the signal from navigation satellites has a fixed precision. Therefore, the relative satellite-receiver geometry plays a major role in determining the precision of estimated positions and times. To minimize the multiplicative effect of navigation satellite geometry on the positional measurement precision, GPS receivers report the dilution of precision (DOP) for horizontal, vertical and 3D position and time. Low DOP values result in s strong geometry and high precision of the estimated position while high DOP values result in a weak geometry and therefor low precision. The DOP value depends on the number of satellites and their relative geometry. To increase the accuracy of the distance between two locations, a distance is only determined or only used when the DOP values are sufficiently low, which indicates that the locations have a certain precision in that specific second. An example of a poor dilution of precision is shown in FIG. 6. An example of a good dilution of precision is shown on FIG. 7

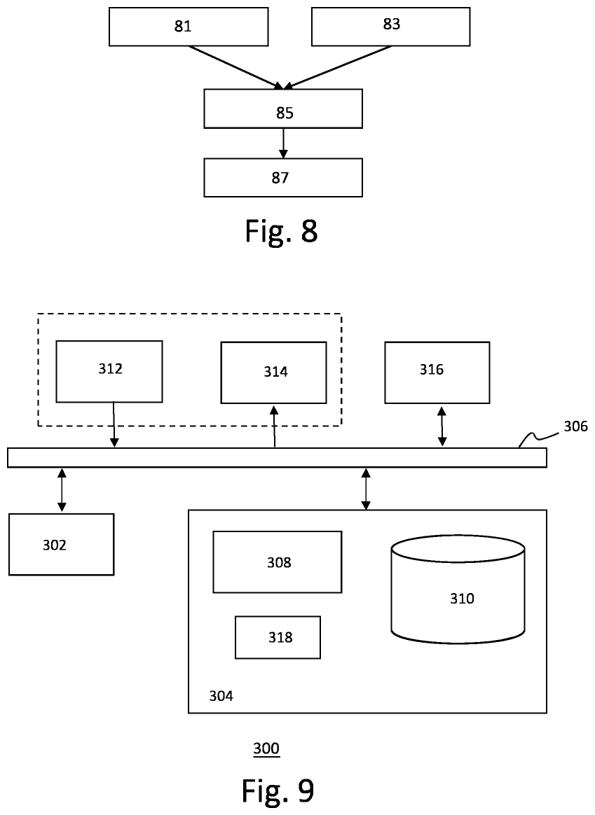

A first embodiment of the method of the invention is shown in FIG. 8. A step 81 comprises determining a first location of a first device and a second location of a second device. The first location and the second location are obtained using a satellite navigation system. A step 83 comprises determining first constellation information representing a satellite constellation used for obtaining the first location and second constellation information representing a satellite constellation used for obtaining the second location. A step 85 comprises determining whether the first constellation information and the second constellation information match. A step 87 comprises determining and using a distance between the first location and the second location if the first constellation information and the second constellation information are determined to match.

FIG. 9 depicts a block diagram illustrating an exemplary data processing system that may perform the method as described with reference to FIG. 8.

As shown in FIG. 9, the data processing system 300 may include at least one processor 302 coupled to memory elements 304 through a system bus 306. As such, the data processing system may store program code within memory elements 304. Further, the processor 302 may execute the program code accessed from the memory elements 304 via a system bus 306. In one aspect, the data processing system may be implemented as a computer that is suitable for storing and/or executing program code. It should be appreciated, however, that the data processing system 300 may be implemented in the form of any system including a processor and a memory that is capable of performing the functions described within this specification.

The memory elements 304 may include one or more physical memory devices such as, for example, local memory 308 and one or more bulk storage devices 310. The local memory may refer to random access memory or other non-persistent memory device(s) generally used during actual execution of the program code. A bulk storage device may be implemented as a hard drive or other persistent data storage device. The processing system 300 may also include one or more cache memories (not shown) that provide temporary storage of at least some program code in order to reduce the quantity of times program code must be retrieved from the bulk storage device 310 during execution.

Input/output (I/O) devices depicted as an input device 312 and an output device 314 optionally can be coupled to the data processing system. Examples of input devices may include, but are not limited to, a keyboard, a pointing device such as a mouse, or the like. Examples of output devices may include, but are not limited to, a monitor or a display, speakers, or the like. Input and/or output devices may be coupled to the data processing system either directly or through intervening I/O controllers.

In an embodiment, the input and the output devices may be implemented as a combined input/output device (illustrated in FIG. 9 with a dashed line surrounding the input device 312 and the output device 314). An example of such a combined device is a touch sensitive display, also sometimes referred to as a “touch screen display” or simply “touch screen”. In such an embodiment, input to the device may be provided by a movement of a physical object, such as e.g. a stylus or a finger of a user, on or near the touch screen display.

A network adapter 316 may also be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 300, and a data transmitter for transmitting data from the data processing system 300 to said systems, devices and/or networks. Modems, cable modems, and Ethernet cards are examples of different types of network adapter that may be used with the data processing system 300.

As pictured in FIG. 9, the memory elements 304 may store an application 318. In various embodiments, the application 318 may be stored in the local memory 308, the one or more bulk storage devices 310, or separate from the local memory and the bulk storage devices. It should be appreciated that the data processing system 300 may further execute an operating system (not shown in FIG. 9) that can facilitate execution of the application 318. The application 318, being implemented in the form of executable program code, can be executed by the data processing system 300, e.g., by the processor 302. Responsive to executing the application, the data processing system 300 may be configured to perform one or more operations or method steps described herein.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 302 described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration, but is not intended to be exhaustive or limited to the implementations in the form disclosed. Many modifications and variations will be apparent to those of ordinary skill in the art without departing from the scope and spirit of the present invention. The embodiments were chosen and described in order to best explain the principles and some practical applications of the present invention, and to enable others of ordinary skill in the art to understand the present invention for various embodiments with various modifications as are suited to the particular use contemplated.

1. An electronic device comprising at least one processor configured to:
determine a first location of a first device and a second location of a second device, said first location and said second location being obtained using a beacon navigation system,
determine first constellation information representing a beacon constellation used for obtaining said first location and second constellation information representing a beacon constellation used for obtaining said second location,
determine whether said first constellation information and said second constellation information match, and
determine and use a distance between said first location and said second location if said first constellation information and said second constellation information are determined to match;
wherein said first device and said second device are outdoor luminaires and/or are part of a sensor grid.

2. An electronic device as claimed in claim 1, wherein said at least one processor is configured to use said distance between said first location and said second location by configuring at least one of said first device and said second device based on said distance.

3. An electronic device as claimed in claim 1, wherein said at least one processor is configured to use said distance between said first location and said second location by comparing said distance with an expected distance and providing a warning if a difference between said distance and said expected distance exceeds a predetermined threshold.

4. An electronic device as claimed in claim 3, wherein said expected distance is a distance between a previously determined first location of said first device and a previously determined second location of said second device, said previously determined first location and said previously determined second location being obtained using said beacon navigation system.

5. An electronic device as claimed in claim 1, wherein said at least one processor is configured to:
determine a dilution of precision value in relation to at least one of said first constellation information and said second constellation information;
compare said dilution of precision value with a predetermined value; and
determine and use said distance between said first location and said second location if said first constellation information and said second constellation information are determined to match and said determined dilution of precision value is lower than said predetermined value.

6. An electronic device as claimed in claim 1, wherein said at least one processor is configured to:
determine a new first location of said first device and a new second location of said second device if said first constellation information and said second constellation information are determined not to match, said new first location and said new second location being obtained using said beacon navigation system;
determine new first constellation information representing a beacon constellation used for obtaining said new first location and new second constellation information representing a beacon constellation used for obtaining said new second location;
determine whether said new first constellation information and said new second constellation information match; and
determine and use a distance between said new first location and said new second location if said new first constellation information and said new second constellation information are determined to match.

7. An electronic device as claimed in claim 1, wherein said at least one processor is configured to determine said distance between said first location and said second location and use said distance if said distance is lower than a predetermined maximum distance and said first constellation information and said second constellation information are determined to match.

8. (canceled)

9. An electronic device as claimed in claim 1, wherein said first device and said second device are outdoor luminaires on different light poles, wherein a distance between said different light poles is 30 kilometers or less.

10. An electronic device as claimed in claim 9, wherein said first device and said second device are outdoor luminaires on neighboring light poles.

11. An electronic device as claimed in claim 9, wherein said at least one processor is configured to:
determine a third location of a third device, said third device being an outdoor luminaire on the same light pole as said second device and said third location being obtained using said beacon navigation system,
determine third constellation information representing a beacon constellation used for obtaining said third location,
determine whether said first constellation information, said second constellation information and said third constellation information match,
determine a distance between said first location and said second location and a further distance between said first location and said third location if said first constellation information, said second constellation information and said third constellation information are determined to match,
compare said distance with said further distance, and
use a result of said comparison.

12. An electronic device as claimed in claim 1, wherein said beacon navigation system is the Global Positioning System.

13. A method of determining a distance between devices, comprising:
determining a first location of a first device and a second location of a second device, said first location and said second location being obtained using a beacon navigation system;
determining first constellation information representing a beacon constellation used for obtaining said first location and second constellation information representing a beacon constellation used for obtaining said second location;
determining whether said first constellation information and said second constellation information match; and
determining and using a distance between said first location and said second location if said first constellation information and said second constellation information are determined to match;
wherein said first device and said second device are outdoor luminaires and/or are part of a sensor grid.

14. A computer program or suite of computer programs comprising at least one software code portion or a computer program product storing at least one software code portion, the software code portion, when run on a computer system, being configured for enabling the method of claim 13 to be performed.
